(19) United States
(12) Patent Application Publication
(10) Pub. No.: US 2026/0331376 A1
(43) Pub. Date: Oct. 22, 2026

(54) MULTILAYER ELECTRONIC COMPONENT

(71) Applicant: SAMSUNG ELECTRO-MECHANICS CO., LTD., Suwon-si (KR)

(72) Inventors: Hyun Sik CHAE, Suwon-si (KR); Ji Hyeon LEE, Suwon-si (KR); Eun Jung LEE, Suwon-si (KR); Jong Ho LEE, Suwon-si (KR)

(73) Assignee: SAMSUNG ELECTRO-MECHANICS CO., LTD., Suwon-si (KR)

(21) Appl. No.: 19/577,819

(22) Filed: Mar. 25, 2026

(30) Foreign Application Priority Data
Apr. 18, 2025 (KR) 10-2025-0050813

(51) Int. Cl. H01G 4/30

(52) U.S. Cl. CPC H01G 4/30

(57) ABSTRACT

A multilayer electronic component according to an embodiment of the present disclosure may include a body including a capacitance formation portion including a dielectric layer and internal electrodes alternately disposed with the dielectric layer in a thickness direction, first and second surfaces opposing each other in the thickness direction, third and fourth surfaces connected to the first and second surfaces and opposing each other in a length direction, fifth and sixth surfaces connected to the first to fourth surfaces and opposing each other in a width direction, external electrodes disposed on the third and fourth surfaces, respectively, and side margin portions disposed on the fifth and sixth surfaces, respectively, wherein the side margin portion contains Ba, Ti and Si, wherein a molar ratio of Ba/(Ti+Si) measured in at least a portion of the side margin is 0.5173 or greater and 0.5323 or less.

### CROSS-REFERENCE TO RELATED APPLICATION(S)

This application claims benefit of priority to Korean Patent Application No. 10-2025-0050813 filed on Apr. 18, 2025 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom.

An MLCC may be used as a component in various electronic devices due to having a small size, ensuring high capacitance and being easily mounted.

In order to miniaturize and increase the high capacitance of an MLCC, maximizing the effective area of the internal electrode is required. To maximize the width direction area of the internal electrode, a method has been applied in which a sheet for forming the side margin portions is separately attached to both surfaces of a multilayer chip in the width direction before sintering and then sintering the chip.

A degree of adhesion between the side margin portions and a ceramic body, sintering behavior of the side margin portions, a microstructure of the side margin, and the like, are factors greatly affecting the reliability of an MLCC. Therefore, research into an optimal design of components configuring a sheet for forming the side margin portions is required.

### RELATED ART DOCUMENT

### Patent Document

(Patent document 1) Korean Patent No. 10-2015-0135092

### SUMMARY

An aspect of the present disclosure is to provide a highly reliable multilayer electronic component.

However, problems to be solved by the present disclosure are not limited to the above, and will be more easily understood in the process of describing specific embodiments of the present disclosure.

A multilayer electronic component according to an embodiment of the present disclosure may comprise: a body including a capacitance formation portion including a dielectric layer and internal electrodes alternately disposed with the dielectric layer in a thickness direction, first and second surfaces opposing each other in the thickness direction, third and fourth surfaces connected to the first and second surfaces and opposing each other in a length direction, fifth and sixth surfaces connected to the first to fourth surfaces and opposing each other in a width direction, an external electrode disposed on the third and fourth surfaces, and a side margin portion disposed on the fifth and sixth surfaces, wherein the side margin portion includes Ba, Ti and Si, wherein a molar ratio of Ba/(Ti+Si) measured in at least a portion of the side margin is 0.5173 or greater and 0.5323 or less.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a multilayer electronic component according to an embodiment of the present disclosure.

FIG. 2 is a perspective view schematically illustrating a body and side margin portions of the multilayer electronic component illustrated in FIG. 1.

FIG. 3 is a perspective view schematically illustrating a body of the multilayer electronic component illustrated in FIG. 1.

FIG. 4 schematically illustrates a cross-sectional view taken along line I-I′ of FIG. 1.

FIG. 5 schematically illustrates a cross-sectional view taken along line II-II′ of FIG. 1.

FIG. 6 schematically illustrates the cross-sectional view of FIG. 5 without internal electrodes.

FIG. 7 is a graph illustrating BDV Weibull distribution of embodiments of the present disclosure and comparative examples.

FIG. 8 is a graph illustrating MTTF Weibull distribution of embodiments of the present disclosure and comparative examples.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, an X-direction may be defined as a thickness T direction, a Y-direction as a length L direction, and a Z-direction as a width W direction. In the present disclosure, “thickness” may refer to a size in the thickness direction, “length” may refer to a size in the length direction, and “width” may refer to a size in the width direction.

### Multilayer Electronic Component

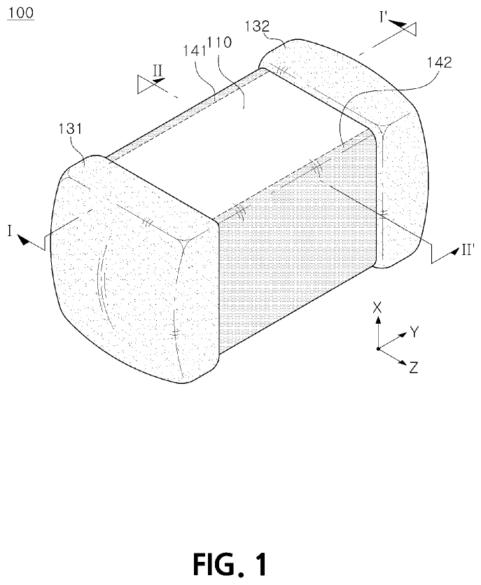

FIG. 1 is a perspective view schematically illustrating a multilayer electronic component according to an embodiment of the present disclosure.

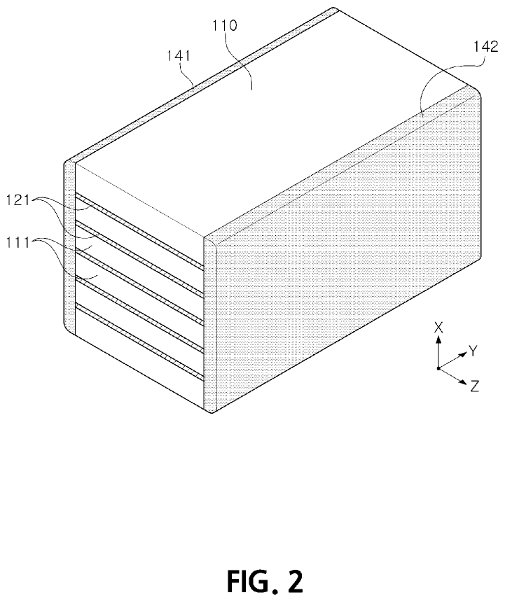

FIG. 2 is a perspective view schematically illustrating a body and side margin portions of the multilayer electronic component illustrated in FIG. 1.

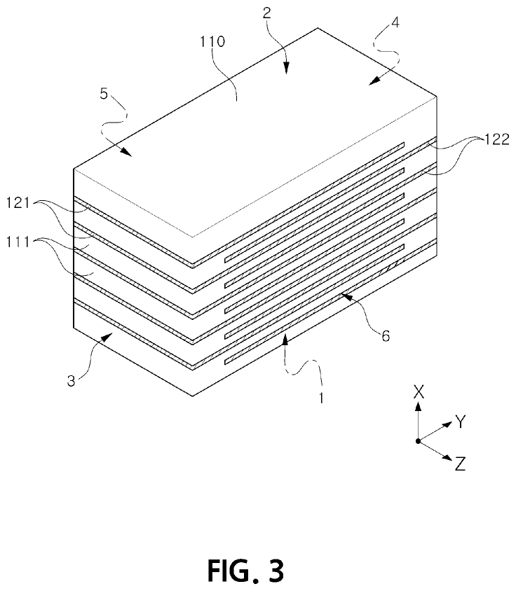

FIG. 3 is a perspective view schematically illustrating a body of the multilayer electronic component illustrated in FIG. 1.

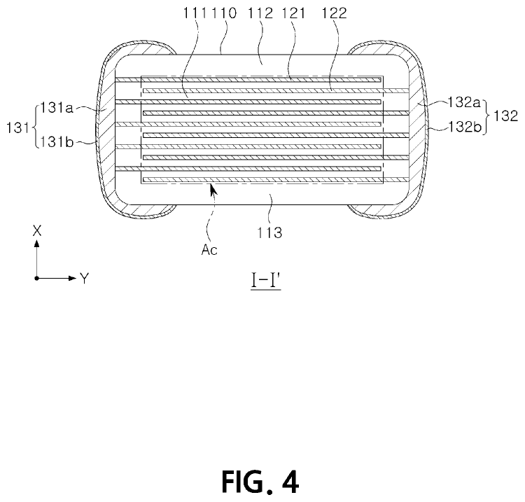

FIG. 4 schematically illustrates a cross-sectional view taken along line I-I′ of FIG. 1.

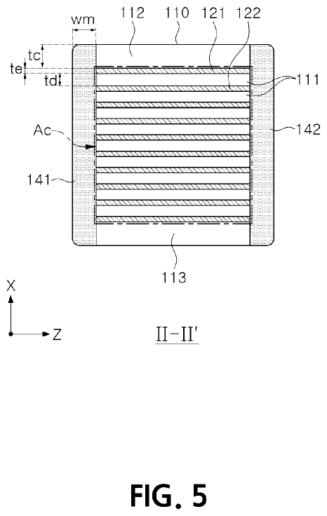

FIG. 5 schematically illustrates a cross-sectional view taken along line II-II′ of FIG. 1.

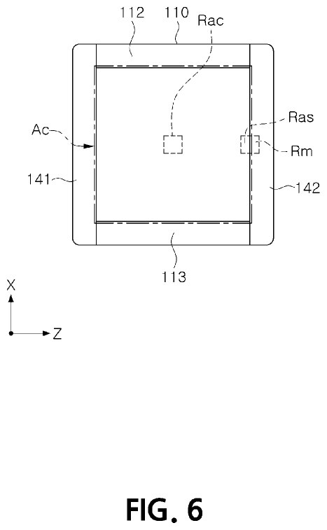

FIG. 6 schematically illustrates a cross-sectional view of FIG. 5 excluding internal electrodes.

Hereinafter, a multilayer electronic component 100 according to an embodiment of the present disclosure will be described in detail with reference to FIGS. 1 to 6. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

A length of the multilayer electronic component 100 may be greater than a width and thickness of the multilayer electronic component 100, respectively. However, the present disclosure is not limited thereto, and for example, the length of the multilayer electronic component 100 may be smaller than the width of the multilayer electronic component 100. For example, the width of the multilayer electronic component 100 may be smaller or greater than the thickness of the multilayer electronic component 100. The length, width, and thickness of the multilayer electronic component 100 may vary depending on the specifications or characteristics of the multilayer electronic component 100.

The multilayer electronic component 100 may include a body 110, external electrodes 131 and 132, and side margin portions 141 and 142.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for the corner portions of the body 110 after sintering, the body 110 may not have a hexahedral shape with entirely straight lines, but may have a substantially hexahedral shape.

The body 110 may have first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

The body 110 may include a capacitance formation portion Ac disposed inside the body 110, and forms a capacitance, including a dielectric layer 111 and internal electrodes 121 and 122 disposed alternately with the dielectric layer 111 in the thickness direction. A plurality of dielectric layers 111 is in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite compound represented by ABO₃ may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃ or (Ca₁₋ₓSrₓ)(Zr_{1-y}Ti_{y})O₃ (0<x≤0.5, 0<y≤0.5).

An average thickness td of the dielectric layer 111 is not particularly limited. The average thickness td of the dielectric layer 111 may be, for example, 0.1 μm to 1.0 μm. For example, when the multilayer electronic component 100 has 0603 size (length: about 0.6 mm, width: about 0.3 mm, thickness: about 0.3 mm) or less, the average thickness td of the dielectric layer 111 may be 0.3 μm to 0.7 μm.

The body 110 may include a first internal electrode 121 and a second internal electrode 122 that are alternately disposed with the dielectric layer 111 interposed therebetween. The first internal electrode 121 may be exposed to the third, fifth, and sixth surfaces 3, 5, and 6, but may be spaced apart from the fourth surface 4. The second internal electrode 122 may be exposed to the fourth, fifth, and sixth surfaces 4, 5 and 6 but may be spaced apart from the third surface 3. One end portion of the internal electrodes 121 and 122 in the length direction may contact the external electrodes 131 and 132, and both end portions of the internal electrodes 121 and 122 in the width direction may contact side margin portions 141 and 142.

The conductive metal included in the internal electrodes 121 and 122 may be one or more of Ni, Cu, Pd, Ag, Au, Pt, Sn, W, Ti, and alloys thereof, for example, it may include Ni, but the present disclosure is not limited thereto.

An average thickness the of the internal electrodes 121 and 122 is not particularly limited. The average thicknesses the of the internal electrode 121 and 122 may be, for example, 0.1 μm to 1.0 μm. For example, when the multilayer electronic component 100 has 0603 size (length: about 0.6 mm, width: about 0.3 mm, thickness: about 0.3 mm) or less, the average thicknesses the of the internal electrodes 121 and 122 may be 0.4 μm to 0.6 μm.

The average thickness td of the dielectric layer 111 and the average thickness the of the internal electrodes 121 and 122 may be measured by scanning a cross-section of the multilayer electronic component 100 in the width direction and thickness direction with a scanning electron microscope SEM of 10,000× magnification. More specifically, the average thickness td of the dielectric layer 111 may be measured by calculating the average after measuring the thickness at a plurality of points of one dielectric layer 111, for example, at 5 points equally spaced apart from each other in the width direction, and then determining the average value thereof. In addition, the average thicknesses the of the internal electrodes 121 and 122 may be measured by calculating the average after measuring the thicknesses at a plurality of points of one internal electrode 121 and 122, for example, at 5 points equally spaced apart from each other in the width direction. The 5 points equally spaced apart from each other may be designated in the capacitance formation portion Ac. Meanwhile, when the average value measurements are performed for each of 10 dielectric layers 111 and 10 internal electrodes 121 and 122, and then the average values are calculated, the average thickness td of the dielectric layer 111 and the average thicknesses the of the internal electrodes 121 and 122 may be further generalized.

The body 110 may include cover portions 112 and 113 respectively disposed on both surfaces of the capacitance formation portion Ac opposing in the width direction. The cover portions 112 and 113 may have a similar configuration to the dielectric layer 111 except for not including an internal electrode.

An average thicknesses tc of the cover portions 112 and 113 may not be particularly limited. The average thickness tc of the cover portions 112 and 113 may be, for example, 5 μm or more and 100 μm or less. For example, when the multilayer electronic component 100 has 0603 size (length: about 0.6 mm, width: about 0.3 mm, thickness: about 0.3 mm) or less, the average thickness tc of the cover portions 112 and 113 may be 10 μm or more and 30 μm or less. The average thicknesses tc of the cover portions 112 and 113 may refer to an average thickness of each of a first cover portion 112 and a second cover portion 113.

The average thickness tc of the cover portions 112 and 113 may be an average value of the thicknesses of the cover portions 112 and 113 measured at 5 points equally spaced apart from each other in a cross-section of the multilayer electronic component 100 in the width and thickness direction.

External electrodes 131, 132 may be disposed on the third and fourth surfaces 3 and 4, respectively. The multilayer electronic component 100 may include the first external electrode 131 disposed on the third surface 3 and the second external electrode 132 disposed on the fourth surface 4. The first and second external electrodes 131 and 132 may extend onto portions of the first, second, fifth, and sixth surfaces 1, 2, 5, and 6, respectively.

Types or shapes of the external electrodes 131 and 132 may not be particularly limited, and may have a multilayer structure. For example, the external electrodes 131 and 132 may include base electrode layers 131a and 132a in contact with the internal electrodes 121 and 122 and plating layers 131b and 132b disposed on the base electrode layers 131a and 132a.

The base electrode layers 131a and 132a may be sintered electrode layers including metal and glass. The metal included in the base electrode layers 131a and 132a may include, for example, Cu, Ni, Pd, Pt, Au, Ag, Pb, and/or alloys thereof. The glass included in the base electrode layers 131a and 132a may include, for example, one or more oxides of Ba, Ca, Zn, Al, B, and Si.

Meanwhile, the base electrode layers 131a and 132a may be configured by only the sintered electrode layer, but the present disclosure is not limited thereto, and the base electrode layers 131a, 132a may include a sintered electrode layer including metal and glass, and a resin electrode layer disposed on the sintered electrode layer and including metal particles and resin.

The metal particles included in the resin electrode layer may include one or more of spherical particles and flake-shaped particles. The metal particles included in the resin electrode layer may include, for example, Cu, Ni, Pd, Pt, Au, Ag, Pb, Sn, and/or alloys thereof. The resin included in the resin electrode layer may include, for example, one or more of epoxy resin, acrylic resin, and ethyl cellulose.

The plating layers 131b, 132b may include, for example, Ni, Sn, Pd and/or alloys thereof, and may be formed of a plurality of layers. The plating layers 131b and 132b may be, for example, Ni plating layer or Sn plating layer, and may also be in the form in which the Ni plating layer and the Sn plating layer are formed sequentially thereon. Additionally, the plating layers 131b and 132b may include a plurality of Ni plating layers and/or a plurality of Sn plating layers.

Although the diagram illustrates a structure in which a multilayer electronic component 100 has two external electrodes 131 and 132, it may not be limited thereto, and the number or shape of the external electrodes 131 and 132 may be changed depending on the shape of the internal electrodes 121 and 122 or other purposes.

The side margin portions 114 and 115 may be disposed on the fifth and sixth surfaces 5 and 6, respectively. The multilayer electronic component 100 may include a first side margin portions 114 disposed on the fifth surface 5 and a second side margin portion 115 disposed on the sixth surface 6.

The side margin portions 114 and 115 may include a perovskite-type compound represented by ABO₃ as a main component and, the perovskite-type compound represented by ABO₃ may include one or more of, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), or Ba(Ti_{1-y}Zr_{y})O₃ (0<y<1). That is, the side margin portions 141 and 142 may include Ba and Ti. The side margin portions 141 and 142 may further include one or more of Ca and Zr to prevent dielectric characteristics from being deteriorated under high temperature/high voltage conditions, but the present disclosure is not limited thereto.

Meanwhile, in the present disclosure, the “main component” of the side margin portions 141 and 142 may refer to a component occupying a relatively large weight ratio or atomic number ratio compared to other components, and may refer to a component exceeding 50 wt % based on the weight of the entire composition or the entire side margin portion, exceeding 50 at % based on the number of atoms, or exceeding 50 mol % based on the number of moles.

When a composition of the dielectric layer 111 included in the capacitance formation portion Ac and the composition of the side margin portions 141 and 142 are the same, sintering of the capacitance formation portion Ac may occur before sintering of the side margin portions 141 and 142. This is because the internal electrodes 121 and 122 including a conductive metal having a lower sintering initiation temperature than dielectric material, are disposed in the capacitance formation portion Ac. When a sintering mismatch occurs between the body 110 and the side margin portions 141 and 142, it may lead to reduced reliability due to a shape defect of the multilayer electronic component 100.

Accordingly, according to an embodiment of the present disclosure, the side margin portions 141 and 142 may include Si. Si is an element contributing to the densification of the side margin portions 141 and 142 by promoting liquid phase sintering as a low-temperature sintering agent and suppressing a grain growth of dielectric grains. By containing Si, the side margin portions 141 and 142 may reduce sintering mismatch between the body 110 and the side margin portions 141 and 142, and improve the reliability of the multilayer electronic component 100.

Meanwhile, when Si is excessively added to the side margin portions 141 and 142, there may be a concern that an abnormal secondary phase may be formed, which may reduce the breakdown voltage of the multilayer electronic component 100. That is, in order to suppress abnormal grain growth in the side margin portions 141 and 142 and secure a withstand voltage characteristics of the multilayer electronic component 100, optimizing the content of Si included in the side margin portions 141 and 142 may be needed.

Accordingly, the multilayer electronic component 100 according to an embodiment of the present disclosure may satisfy a molar ratio of Ba/(Ti+Si) measured in at least a portion of the side margin portions 141 and 142 of 0.5173 or greater and 0.5323 or less. Alternatively, an average molar ratio of Ba/(Ti+Si) measured at the side margin portions 141 and 142 may satisfy 0.5173 or greater and 0.5323 or less. When the numerical range is satisfied, the dielectric grain growth included in the side margin portions 141 and 142 may be effectively controlled, thereby improving the breakdown voltage (BDV) and mean time to failure (MTTF) of the multilayer electronic component 100.

In an embodiment, a molar ratio of Ba/(Ti+Si) measured in at least a portion of the side margin portions 141 and 142 may be less than a molar ratio of Ba/(Ti+Si) measured in the dielectric layer 111 disposed in a central portion of the capacitance formation portion Ac in the width and thickness direction. Alternatively, an average molar ratio of Ba/(Ti+Si) measured in the side margin portions 141 and 142 may be less than an average molar ratio of Ba/(Ti+Si) measured in the dielectric layer 111 disposed in the central portion of the capacitance formation portion Ac in the width and thickness direction. As a result, the reliability of the multilayer electronic component 100 may be more effectively improved by reducing the sintering mismatch between the body 110 and the side margin portions 141 and 142.

The side margin portions 141 and 142 may further include other subcomponents in addition to Si.

### 1) A First Subcomponent

For example, the side margin portions 141 and 142 may further include a first subcomponent including one or more of Al and Sn. Like Si, Al and/or Sn may contribute in suppressing grain growth of dielectric grains included in the side margin portions 141 and 142. In particular, Al and Sn may suppress diffusion of other subcomponents, such as rare earth elements into the interior of the dielectric grains by substituting a B-site of the ABO₃ perovskite compound. As a result, the withstand voltage and high-temperature reliability characteristics of the multilayer electronic component 100 may be improved.

A content of the first subcomponent included in the side margin portions 141 and 142 is not particularly limited. However, when Al and/or Sn are excessively added to the side margin portions 141 and 142, there is a concern that the insulation resistance (IR) of the multilayer electronic component 100 may decrease or the dielectric constant may decrease due to lattice distortion of the ABO₃ perovskite compound. In addition, since Al and Sn, may contribute in suppressing the grain growth of dielectric grains included in the side margin portions 141 and 142 with Si, the reliability of the multilayer electronic component 100 may be improved more effectively by optimizing the contents of Al and Sn in consideration of the content of Si.

In an embodiment, the molar ratio of Ba/(Ti+Si+Al) measured in at least a portion of the side margin portions 141 and 142 may be 0.5089 or more and 0.5250 or less. Alternatively, an average molar ratio of Ba/(Ti+Si+Al) measured at the side margin portions 141 and 142 may be 0.5089 or more and 0.5250 or less. When the numerical range is satisfied, the breakdown voltage (BDV) and mean time to failure (MTTF) of the multilayer electronic component 100 may be improved more effectively.

In an embodiment, a molar ratio of Ba/(Ti+Si+Al+Sn) measured in at least a portion of the side margin portions 141 and 142 may be 0.5029 or greater and 0.5184 or less. Alternatively, an average molar ratio of Ba/(Ti+Si+Al+Sn) measured in the side margin portions 141 and 142 may be 0.5029 or greater and 0.5184 or less. When the numerical range is satisfied, the breakdown voltage (BDV) and mean time to failure (MTTF) of the multilayer electronic component 100 may be improved more effectively.

However, the present disclosure is not limited thereto, and the content of the first subcomponent included in the side margin portions 141 and 142 may be adjusted depending on the characteristics of the intended multilayer electronic component 100 or the content of other subcomponents, and in some cases, the side margin portions 141 and 142 may not include the first subcomponent.

In an embodiment, a molar ratio of Si to Ti (Si/Ti) measured in at least a portion of the side margin portions 141 and 142 may be greater than a molar ratio of Al to Ti measured in at least a portion of the side margin portions 141 and 142 (Al/Ti). Additionally, in an embodiment, the molar ratio of Si to Ti (Si/Ti) measured in at least a portion of the side margin portions 141 and 142 may be greater than the molar ratio of Sn to Ti measured in at least a portion of the side margin portions 141 and 142 (Sn/Ti). For example, the content mol % of Si included in the side margin portions 141 and 142 may be greater than the content mol % of Al and/or the content mol % of Sn included in the side margin portions 141 and 142. As a result, a microstructure of the side margin portions 141 and 142 may be effectively controlled. The molar ratio of Si to Ti (Si/Ti) measured in at least a portion of the side margin portions 141 and 142 may be, for example, 0.0592 or greater and 0.0923 or less, and the molar ratio of Al to Ti (Al/Ti) measured in at least a portion of the side margin portions 141 or 142 may be, for example, 0.0147 or greater and 0.0180 or less, but the present disclosure is not limited thereto.

### 2) A Second Subcomponent

The side margin portions 141 and 142 may further include a second subcomponent including one or more of Dy, Tb, Y, Sc, La, Nd, Eu, Gd, Ho, Er, Yb, and Lu. For example, the side margin portions 141 and 142 may include Dy. A rare earth element included in the second subcomponent may improve a high-temperature accelerated life of the multilayer electronic component 100.

A total content of the second subcomponent included in the side margin portions 141 and 142 may be, for example, more than 0 mol and less than 8.0 mol based on 100 mol of Ti. When the numerical range is satisfied, the reliability of the multilayer electronic component 100 may be improved more effectively. In this case, the total content of the second subcomponent may refer to a total content of rare earth elements included in the side margin portions 141 and 142.

### 3) A Third Subcomponent

The side margin portions 141 and 142 may further include a third subcomponent including one or more of Mn, V, Cr, Fe, Ni, Cu, Co, and Zn. A variable valence acceptor element included in the third subcomponent may lower a sintering temperature of the multilayer electronic component 100 and improve the high-temperature accelerated life.

A total content of the third subcomponent included in the side margin portions 141 and 142 may be, for example, 0.2 mol or greater and 1.4 mol or less based on 100 mol of Ti. When the numerical range is satisfied, the reliability of the multilayer electronic component 100 may be improved more effectively. In this case, the total content of the third subcomponent may refer to a total content of the variable valence acceptor elements included in the side margin portions 141 and 142.

### 4) A Fourth Subcomponent

The side margin portions 141 and 142 may further include a fourth subcomponent including Mg. Mg included in the fourth subcomponent may provide reduction resistance and contribute in increasing an RC value. A content of the fourth subcomponent may be, for example, 2.0 mol or less based on 100 mol of Ti. When the numerical range is satisfied, the reliability of the multilayer electronic component 100 may be improved more effectively. However, the fourth subcomponent is not an essential component, and even if it is not added, a target characteristics may be satisfied by an appropriate input content of other components.

Hereinafter, an example of a method for measuring a content of each component will be described.

First, the multilayer electronic component 100 is polished to a ½ point in the length direction to expose a cross-section in the width-thickness directions (hereinafter, referred to as a measurement cross-section). Thereafter, the contents mol % of Ba, Ti, Si, Al, Sn, or the like (e.g., another element of interest) may be measured using Scanning Electron Microscope-Energy Dispersive X-ray Spectrometer SEM-EDS, Transmission Electron Microscope-Energy Dispersive X-ray Spectrometer TEM-EDS, Scanning Transmission Electron Microscope-Energy Dispersive X-ray Spectrometer STEM-EDS, or Field Emission-scanning Electron Microscope-Energy Dispersive X-ray Spectrometer FE-SEM-EDS. Other methods and/or tools appreciated by one of ordinary skill in the art, even if not described in the present disclosure, may also be used.

A measurement location is not particularly limited, but the content mol % of Ba, Ti, Si, Al, Sn, and the like included in the side margin portions 141 and 142 may be measured in a region Rm adjacent to the capacitance formation portion Ac among the side margin portions 141 and 142 in the measurement cross-section. The region Rm adjacent to the capacitance formation portion among the side margin portions may be designated at a central portion of the side margin portions 141 and 142 in the thickness direction.

Thereafter, a molar ratio of Ba/(Ti+Si), a molar ratio of Ba/(Ti+Si+Al), and/or a molar ratio of Ba/(Ti+Si+Al+Sn) may be measured from the measured contents mol % of Ba, Ti, Si, Al, Sn, and the like.

In addition, in the measurement cross-sections, the molar ratio of Ba/(Ti+Si), the molar ratio of Ba/(Ti+Si+Al), and/or the molar ratio of Ba/(Ti+Si+Al+Sn) are measured, respectively, using EDS in any 5 or more regions spaced apart from each other among the side margin portions 141 and 142, and then determining the average value thereof, and then the average molar ratio of Ba/(Ti+Si), the average molar ratio of Ba/(Ti+Si+Al), and/or the average molar ratio of Ba/(Ti+Si+Al+Sn) in the side margin portions 141 and 142 may be measured.

In addition, in the measurement cross-sections, the content mol % of each component may be measured in the same way in the dielectric layer 111 disposed at the central portion Rac of the capacitance formation portion Ac in the width and thickness direction, thereby calculating the molar ratio of Ba/(Ti+Si), and the like.

The dielectric layer 111 of the side margin portions 141 and 142 and the capacitance formation portion Ac may include a plurality of dielectric grains, respectively. The dielectric grains included in the side margin portions 141 and 142 may be defined as a first dielectric grains, and the dielectric grains included in the dielectric layer 111 may be defined as second dielectric grains.

At least one of the plurality of first dielectric grains may be a dielectric grain having a core-shell structure, and at least one of the plurality of second dielectric grains may be a dielectric grain having a core-shell structure. Additionally, at least one of the plurality of first dielectric grains may be a dielectric grain not having a core-shell structure, and at least one of the plurality of second dielectric grains may be a dielectric grain not having a core-shell structure, but the present disclosure is not limited thereto.

An average size of the plurality of first dielectric grains may be less than an average size of the plurality of second dielectric grains, but the present disclosure is not limited thereto.

In an embodiment, an average size G1 of the dielectric grains included in a region adjacent to the side margin portions 141 and 142 of the capacitance formation portion Ac may be 230 nm or greater and 280 nm or less. In an embodiment, an average size G2 of the dielectric grains included in a region adjacent to the capacitance formation portion Ac of the side margin portions 141 and 142 may be 130 nm or greater and 190 nm or less. By satisfying the numerical range, the reliability and dielectric characteristics of the multilayer electronic component 100 may be improved. However, the present disclosure is not limited thereto, and the average size of the dielectric grains included in each region may be determined by various factors such as a size of the ceramic powder grain or a content of subcomponents.

Hereinafter, an example of a method for measuring the average sizes G1 and G2 of dielectric grains will be described.

First, the measurement cross-section is exposed by polishing up to the ½ point of the multilayer electronic component 100 in the length direction. The G1 may be measured by analyzing an image taken with a scanning electron microscope SEM of a region Ras adjacent to the side margin of the capacitance formation portion using an image analysis program. Among the capacitance formation portions, the region Ras adjacent to the side margin portion may be designated at the central portion of the capacitance formation portion Ac in the thickness direction. The G2 may be measured by analyzing an image taken with a scanning electron microscope SEM of a region Rm adjacent to the capacitance formation portion of the side margin portions using an image analysis program. Among the side margin portions, the region Rm adjacent to the capacitance formation portion may be designated at the central portion of the side margin portions 141 and 142 in the thickness direction. Other methods and/or tools appreciated by one of ordinary skill in the art, even if not described in the present disclosure, may also be used.

In addition, the region Ras adjacent to the side margin portion of the capacitance formation portions and the region Rm adjacent to the capacitance formation portion of the side margin portions may each be designated in an image in which the capacitance formation portion Ac and the side margin portions 141 and 142 may be captured at once with a scanning electron microscope SEM so that an interface between the capacitance formation portion Ac and the side margin portions 141 and 142 may be disposed at the central of the image.

For example, in the measurement cross-section, the image is taken of the capacitance formation portion Ac and the side margin portions 141 and 142 at a magnification of 50,000× so that the interface between the capacitance formation portion Ac and the side margin portions 141 and 142 may be disposed at the central of the image. In the image above, a region corresponding to the capacitance formation portion Ac may be defined as a region Ras adjacent to the side margin portion of the capacitance formation portions, and in the image above, a region corresponding to the side margin portions 141 and 142 may be defined as a region Rm adjacent to the capacitance formation portion of the side margin portions.

An average width wm of the side margin portions 141 and 142 is not particularly limited. The average width wm of the side margin portions 141 and 142 may be, for example, 3 μm or greater and 100 μm or less. For example, when the multilayer electronic component 100 has a size of 0603 size (length: about 0.6 mm, width: about 0.3 mm, thickness: about 0.3 mm) or less, the average width wm of the side margin portions 141 and 142 may be 3 μm or greater and 20 μm or less. The average width wm of the side margin portions 141 and 142 refers to the average width of the first side margin portion 141 and the second side margin portion 142, respectively.

The average width wm of the side margin portions 141 and 142 may be an average value of the width of the side margin portions 141 and 142 measured at 5 points equally spaced apart from each other in a cross-section of the multilayer electronic component 100 in the thickness direction on the width direction and thickness direction.

Hereinafter, an example of a method for forming a multilayer electronic component 100 will be described. However, a method for manufacturing the multilayer electronic component 100 is not limited to thereto.

First, a ceramic powder for forming a dielectric layer 111 is prepared. The ceramic powder may be a perovskite compound powder represented by ABO₃. The ceramic powder may include, for example, one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. Methods for synthesizing the ceramic powder may include, for example, a solid phase method, a sol-gel method, a hydrothermal synthesis method, and the like, but the present disclosure is not limited thereto. Next, the prepared ceramic powder is dried and ground, and then mixed with an organic solvent such as ethanol, a binder such as polyvinyl butyral, and the like to prepare a ceramic slurry, and then the ceramic slurry is applied and dried on a carrier film to prepare a sheet for forming a dielectric layer.

Next, an internal electrode pattern is formed by printing an internal electrode conductive paste containing metal powder, binder, organic solvent, or the like to a predetermined thickness on a dielectric layer forming sheet using a screen printing method or gravure printing method.

Thereafter, after peeling the dielectric layer forming sheets having the internal electrode pattern printed thereon from the carrier film, and then the dielectric layer forming sheet with the internal electrode pattern printed thereon stacked and pressed in a predetermined number of layers to form a ceramic laminate. On the upper and lower portions of the ceramic laminate, a sheet forming a cover portion without an internal electrode pattern, may be stacked in a predetermined amount of layers to form the cover portions 112 and 113 after sintering. Thereafter, the ceramic laminate is cut to have a predetermined size of a chip. In this case, the end portions of the internal electrode patterns may be exposed on both surfaces of the chip, opposing each other in the third direction.

Next, a sheet for forming a margin portion may be attached to both surfaces of the cut chip opposing in the third direction and then sintered to form the body 110 and the side margin portions 114 and 115.

The sheet for forming the side margin portion may be formed in a similar method to the sheet for forming the dielectric layer, but the type and content of subcomponents included in the sheet for forming the side margin portion may be different from those included in the sheet for forming the dielectric layer.

For example, a content of Si included in the sheet for forming the side margin portion may be greater than a content of Si included in the sheet for forming the dielectric layer. The content mol % of Si included in the sheet for forming the side margin portion may be 5.0 mol or greater and 12.0 mol or less with respect to 100 mol of a main component of ABO₃, but the present disclosure is not limited thereto. The content mol % of Si included in the sheet for forming the dielectric layer may be 3.0 mol or more and 5.0 mol or less with respect to 100 mol of the main component of ABO₃, but the present disclosure is not limited thereto.

The sintering may be performed, for example, in a 1.0% H₂/99.0% N₂~3.5% H₂/96.5% N₂ (H₂O/H₂/N₂ atmosphere) at a temperature of 1000° C. or higher and 1400° C. or lower for 1 to 3 hours, but the present disclosure is not limited thereto.

Next, the external electrodes 131 and 132 may be formed. For example, when the base electrode layers 131a and 132a includes a sintered electrode layer, the body 110 may be dipped in an external electrode conductive paste containing metal powder, glass frit, binder, and organic solvent, and the like, and then the external electrode conductive paste is sintered at a temperature of 500° C. to 900° C. to form a sintered electrode layer.

For example, when the base electrode layers 131a and 132a includes a resin electrode layer, the body may be dipped in a conductive resin composition including metal powder, resin, binder, and organic solvent, and then cured and heat-treated at a temperature of 250° C. to 550° C. to form a resin electrode layer.

In addition, plating layers 131b and 132b may be formed on the base electrode layers 131a and 132a by additionally performing an electrolytic plating method and/or an electroless plating method.

### Experimental Example

Hereinafter, the present disclosure will be described in more detail through experimental examples. However, the following experimental examples are intended to aid in a specific understanding of the present disclosure, and the scope of the present disclosure is not limited by the following examples.

### 1) Manufacturing Sample Chip

First, an internal electrode conductive paste including Ni powder, organic solvent, and binder, and the like, was applied to the sheet for forming the dielectric layer of the examples and comparative examples with a predetermined thickness to form the internal electrode pattern, and then the sheets for forming the dielectric layer, with the internal electrode pattern formed, then stacked and pressed to form the ceramic laminate.

Thereafter, the ceramic laminate may be cut to a predetermined chip size, and a sheet for forming the side margin portions may be attached to both surfaces of the cut chip opposing each other in the third direction. The sheet for forming the side margin portions of Comparative Example 1 contained 3.8 mol of SiO₂ based on 100 mol of the ABO₃ main component, the sheet for forming the side margin portion of Example 1 contained 6.8 mol of SiO₂ based on 100 mol of the ABO₃ main component, the sheet for forming the side margin portion of Example 2 contained 8.6 mol of SiO₂ based on 100 mol of the ABO₃ main component, the sheet for forming the side margin portion of Example 3 contained 10.3 mol of SiO₂ based on 100 mol of the ABO₃ main component, and the sheet for forming the side margin portion of Example 4 contained 13.7 mol of SiO₂ based on 100 mol of the ABO₃ main component. In addition, the sheet for forming the side margin portions may contained subcomponents such as Al, Sn, Mg, and/or Dy, and the like.

Next, the body and side margin portions were formed by sintering the chip to which the sheet for forming the side margin was attached. Thereafter, a sample chip of 0603 size (length: approximately 0.6 mm, width: approximately 0.3 mm, thickness: approximately 0.3 mm) was prepared by forming an external electrode on the body.

### 2) Measurement of Molar Ratio Ba/(Ti+Si)

Thereafter, each sample chip was polished to a ½ point in the length direction to expose a cross-section in the width-thickness direction, and then contents mol % of Ba, Ti, Si, Al, Sn, and the like included in the side margin were measured by using FE-SEM-EDS (acceleration voltage: 15 kV, magnification: 50,000×).

Specifically, the content measurement was performed in a region adjacent to the capacitance formation portion of the central portion of the side margin portion in the thickness direction described above. Thereafter, the molar ratio of Ba/(Ti+Si), the molar ratio of Ba/(Ti+Si+Al), and/or the molar ratio of Ba/(Ti+Si+Al+Sn) were calculated from the measured contents mol % of Ba, Ti, Si, Al, Sn, and the like, and are listed in Table 1 below.

TABLE 1

| | Compar- | | | | Compar- |
|---|---|---|---|---|---|
| | ative | Exam- | Exam- | Exam- | ative |
| Division | Example 1 | ple 1 | ple 2 | ple 3 | Example 2 |
| Si (mol %) | 0.48 | 1.29 | 1.65 | 2.00 | 2.60 |
| Ti (mol %) | 24.92 | 21.78 | 21.73 | 21.68 | 20.98 |
| Ba (mol %) | 15.26 | 12.28 | 12.27 | 12.25 | 11.85 |
| Al (mol %) | 0.17 | 0.32 | 0.36 | 0.39 | 0.42 |
| Sn (mol %) | 0.25 | 0.30 | 0.30 | 0.29 | 0.28 |
| Zr (mol %) | 0.54 | 0.70 | 0.71 | 0.72 | 0.68 |
| Dy (mol %) | 0 | 0.01 | 0.01 | 0 | 0.03 |
| Ba/(Ti + Si) | 0.6008 | 0.5323 | 0.5248 | 0.5173 | 0.5025 |
| Ba/(Ti + Si + | 0.5968 | 0.5250 | 0.5168 | 0.5089 | 0.4938 |
| Al) | | | | | |
| Ba/(Ti + Si + | 0.5910 | 0.5184 | 0.5104 | 0.5029 | 0.4881 |
| Al + Sn) | | | | | |

### 3) BDV and MTTF Evaluation

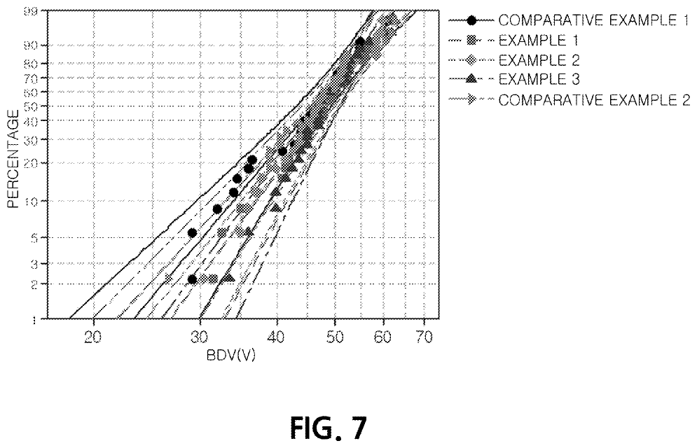

The breakdown voltage BDV evaluation was performed on 60 sample chips each of Example 1, Example 2, Example 3, Comparative Example 1, and Comparative Example 2. By using Keithley 2410, a DC voltage was applied at a step-up speed of 20 V/s, and a voltage value at the point where a leakage current exceeded 20 Ma was defined as a BDV value. FIG. 7 is a graph illustrating a BDV Weibull distribution of the examples and comparative examples. The average BDV values of the examples and comparative examples are listed in Table 2 below.

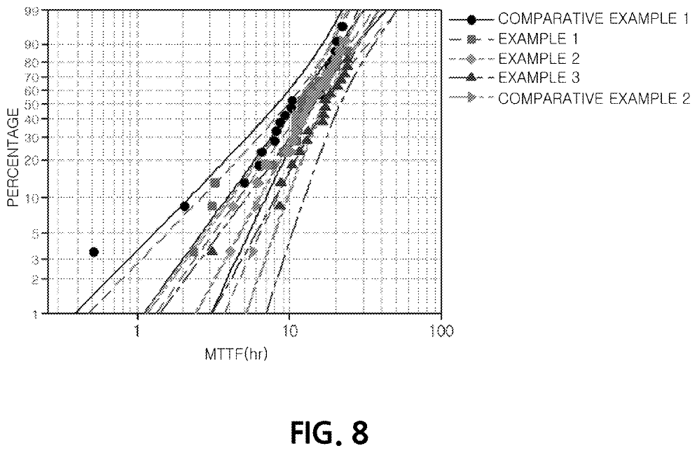

Mean time to failure MTTF evaluation was performed on 60 sample chips each of Example 1, Example 2, Example 3, Comparative Example 1, and Comparative Example 2. Specifically, the time for fixation to occur in an environment of 125° C. and 3Vr was measured. FIG. 8 is a graph illustrating the MTTF Weibull distribution of the examples and comparative examples. The mean time to failure MTTF of the examples and comparative examples is illustrated in Table 2 below.

TABLE 2

| Division | BDV (V) | MTTF (hr) |
|---|---|---|
| Comparative Example 1 | 45.7 | 11.9 |
| Example 1 | 47.8 | 14.0 |
| Example 2 | 47.3 | 14.1 |
| Example 3 | 48.1 | 18.0 |
| Comparative Example 2 | 46.4 | 14.4 |

Referring to Table 1 and Table 2, it may be confirmed that Examples 1 to 3, in which the molar ratio of Ba/(Ti+Si) measured at the side margin is 0.5173 or greater and 0.5323 or less, may have been improved BDV and MTTF compared to Comparative Example 1. In the case of Comparative Example 2, the MTTF may be better than in Examples 1 and 2, but it may be confirmed that the BDV rapidly decreased as the molar ratio of Ba/(Ti+Si) became lower than 0.5173.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the disclosure, the term “connected” includes not only direct connection but also indirect connection through an adhesive layer or the like. Furthermore, the term “electrically connected” includes both physically connected and unconnected connections. The terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

As one of the various effects of the present disclosure, a multilayer electronic component with excellent reliability can be provided.

While the embodiments have been illustrated and described above, it will be configured as apparent to those skilled in the art that modifications and variations could be made without departing from the scope of the present disclosure as defined by the appended claims.

What is claimed is:

1. A multilayer electronic component comprising:
a body including:
a capacitance formation portion including a dielectric layer and internal electrodes alternately disposed with the dielectric layer in a thickness direction,
first and second surfaces opposing each other in the thickness direction,
third and fourth surfaces connected to the first and second surfaces and opposing each other in a length direction, and
fifth and sixth surfaces connected to the first to fourth surfaces and opposing each other in a width direction;
external electrodes disposed on the third and fourth surfaces, respectively; and
side margin portions disposed on the fifth and sixth surfaces, respectively,
wherein the side margin portion includes Ba, Ti and Si,
wherein a molar ratio of Ba/(Ti+Si) measured in at least a portion of the side margin is 0.5173 or greater and 0.5323 or less.

2. The multilayer electronic component of claim 1,
wherein the side margin portion further includes at least one selected from the group consisting of Al and Sn.

3. The multilayer electronic component of claim 2, wherein a molar ratio of Ba/(Ti+Si+Al) measured in the at least the portion of the side margin is 0.5089 or greater and 0.5250 or less.

4. The multilayer electronic component of claim 2, wherein a molar ratio of Ba/(Ti+Si+Al+Sn) measured in the at least the portion of the side margin is 0.5029 or greater and 0.5184 or less.

5. The multilayer electronic component of claim 1, wherein the molar ratio of Ba/(Ti+Si) measured in the at least the portion of the side margin region is smaller than the molar ratio of Ba/(Ti+Si) measured in the dielectric layer disposed in a central region of the capacitance formation portion in the width direction and the thickness direction.

6. The multilayer electronic component of claim 2,
wherein a molar ratio of Si to Ti (Si/Ti) measured in the at least the portion of the side margin portion is greater than a molar ratio of Al to Ti (Al/Ti) measured in the at least the portion of the side margin portion.

7. The multilayer electronic component of claim 2,
wherein a molar ratio of Si to Ti (Si/Ti) measured in the at least the portion of the side margin portion is greater than a molar ratio of Sn to Ti (Sn/Ti) measured in the at least the portion of the side margin portion.

8. The multilayer electronic component of claim 1,
wherein the side margin portion further includes one or more selected from the group consisting of Dy, Tb, Y, Sc, La, Nd, Eu, Gd, Ho, Er, Yb, and Lu.

9. The multilayer electronic component of claim 1,
wherein the side margin portion further includes one or more selected from the group consisting of Mn, V, Cr, Fe, Ni, Cu, Co and Zn.

10. The multilayer electronic component of claim 1, wherein the side margin portion further includes Mg.

11. The multilayer electronic component of claim 1, wherein an average size of dielectric grains included in a region that is in the capacitance formation portion and that is adjacent to the side margin portion is 230 nm or greater and 280 nm or less.

12. The multilayer electronic component of claim 1, wherein an average size of dielectric grains included in a region that is in the side margin portion and that is adjacent to the capacitance formation portion is 130 nm or greater and 190 nm or less.

13. The multilayer electronic component of claim 1, where an end portion of the internal electrodes in the length direction is in contact with the external electrode,
where ends of the internal electrodes in the width direction are in contact with the side margin portion.

14. The multilayer electronic component of claim 1,
wherein the side margin portion further includes at least one selected from the group consisting of Al, Zr, and Sn.
